(19) United States
(12) Patent Application Publication
(10) Pub. No.: US 2023/0407159 A1
(43) Pub. Date: Dec. 21, 2023

(54) IMPREGNATED 3D GRAPHENE AEROGELS FOR ENHANCED THERMAL CONDUCTIVITY

(71) Applicant: Georgia Tech Research Corporation, Atlanta, GA (US)

(72) Inventors: Comas Haynes, Atlanta, GA (US); John Hankinson, Atlanta, GA (US); Jinho Park, Atlanta, GA (US)

(21) Appl. No.: 18/210,358

(22) Filed: Jun. 15, 2023

Related U.S. Application Data
(60) Provisional application No. 63/366,419, filed on Jun. 15, 2022.

(51) Int. Cl. C09K 5/06; C01B 32/194; C01B 32/198

(52) U.S. Cl. CPC C09K 5/063; C01B 32/194; C01B 32/198

(57) ABSTRACT

An exemplary embodiment of the present disclosure provides a system comprising an aerogel and a first phase change material. The aerogel comprises graphene. The first phase change material is imbedded in the aerogel. The system comprises an increased thermal conductivity compared to a thermal conductivity of pure phase change material.

### CROSS-REFERENCE TO RELATED APPLICATIONS

This application claims the benefit of U.S. Provisional Application Ser. No. 63/366,419, filed on 15 Jun. 2022, which is incorporated herein by reference in its entirety as if fully set forth below.

### FIELD OF THE DISCLOSURE

The various embodiments of the present disclosure relate generally to systems with enhanced thermal conductivity, and more particularly to graphene aerogels impregnated with phase change materials.

### BACKGROUND

Phase change materials (PCMs) show great potential for use in thermal load management and energy storage applications. One particularly appealing class of PCM materials is that of organic PCMs like paraffins and polyethylene glycol (PEG). These materials are chemically stable, exhibit a congruent phase change, and are non-corrosive. However, they have one particularly significant drawback: low thermal conductivity (0.1-0.3 W/m·K). The low thermal conductivity causes the phase transition to primarily occur at the surface, making it difficult to rapidly dump energy into (or retrieve stored energy from) the bulk of the material. To combat this shortcoming, researchers have been exploring additives like particulates to enhance the thermal conductivity of the material without significantly decreasing capacity; however, particulate additives like graphene nanoplatelets are prone to aggregation, clumping, and settling. PCMs with particulate additives suffer from inhomogeneous distribution after thermal cycling. Thus, there is a need for systems and methods to create PCMs with increased effective thermal conductivity while maintaining their desirable energy storage properties during thermal cycling.

### BRIEF SUMMARY

The present disclosure relates to phase change materials with enhanced thermal conductivity. An exemplary embodiment of the present disclosure provides a system comprising an aerogel and a first phase change material (“PCM”) imbedded in the aerogel.

In any of the embodiments disclosed herein, the aerogel can comprise graphene.

In any of the embodiments disclosed herein, a thermal conductivity of the system can increase by at least approximately 10 percent compared to a PCM thermal conductivity.

In any of the embodiments disclosed herein, the first PCM can comprise eicosane, docosane, octadecanoic acid, tetradecanol, a polymer, or combinations thereof.

In any of the embodiments disclosed herein, the first PCM can comprise a polymer configured to reversibly crosslink with respective monomers of the polymer based on a phase transition temperature.

In any of the embodiments disclosed herein, the polymer can comprise polyethylene glycol (PEG), polylactide (PLA), polyglycolide (PGA), polydioxanone (PDO), polylactide-co-glycolide (PLGA), or combinations thereof.

In any of the embodiments disclosed herein, the system can comprise from approximately 0.01 wt. % to approximately 3 wt. % of graphene, based on a total weight of the system.

In any of the embodiments disclosed herein, the system can comprise a ratio of graphene to first PCM of between approximately 1:1000 to approximately 1:33.

In any of the embodiments disclosed herein, the system can further comprise a second PCM imbedded in the aerogel. The second PCM can be different than the first PCM.

In any of the embodiments disclosed herein, the aerogel can comprise an oxygen content between approximately 0.1 mol. % and 25 mol. %.

In any of the embodiments disclosed herein, the aerogel can comprise an oxygen content of at least approximately 6 mol. %, and wherein the aerogel is hydrophilic.

In any of the embodiments disclosed herein, the aerogel can comprise an oxygen content equal to or less than approximately 5 mol. %. The aerogel can be hydrophobic.

An exemplary embodiment of the present disclosure provides a method of forming a system comprising phase change material (“PCM”). The method can comprise forming an aerogel and adding a first PCM within the aerogel. The aerogel can comprise graphene. The aerogel can comprise an oxygen content ranging from between approximately 0.1 mol. % to approximately 25 mol. %.

In any of the embodiments disclosed herein, the method can further comprise increasing a thermal conductivity of the system by at least approximately 10 percent compared to a PCM thermal conductivity.

In any of the embodiments disclosed herein, the method can comprise reducing graphene oxide to form graphene.

In any of the embodiments disclosed herein, forming an aerogel can further comprise freeze-drying the graphene to form pores.

In any of the embodiments disclosed herein, adding the first PCM in the aerogel can further comprise exposing the aerogel and the first PCM to a vacuum.

In any of the embodiments disclosed herein, the system can comprise from approximately 0.01 wt. % to approximately 3 wt. % of graphene, based on a total weight of the system.

In any of the embodiments disclosed herein, the first PCM can comprise eicosane, docosane, octadecanoic acid, tetradecanol, polyethylene glycol (PEG), polylactide (PLA), polyglycolide (PGA), polydioxanone (PDO), polylactide-co-glycolide (PLGA), or combinations thereof.

In any of the embodiments disclosed herein, the method can further comprise increasing an oxygen content in the aerogel to at least approximately 6 mol. % to form a hydrophilic aerogel.

In any of the embodiments disclosed herein, the method can further comprise decreasing an oxygen content in the aerogel equal to or less than approximately 5 mol. % to form a hydrophobic aerogel.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic of an example phase change material, in accordance with an exemplary embodiment of the present invention.

FIG. 2A through 2D provide XRD data of oxygen-to-carbon ratio (“0/C ratio”) in example aerogels, in accordance with an exemplary embodiment of the present invention.

FIG. 3 provides step-by-step illustrations of an example aerogel with phase change material, in accordance with an exemplary embodiment of the present invention.

FIGS. 4A through 4C provide scanning electron microscope (SEM) images of graphene aerogels prepared at different wt. ratios of reducing agent to graphene oxide, including 3:1 (Gr-1) (FIG. 4A), 3:2 (Gr-2) (FIG. 4B), and 3:4 (Gr-3) (FIG. 4C), respectively. Pores in each graphene aerogels are outlined in gray broken lines, in accordance with an exemplary embodiment of the present invention.

FIGS. 5A through 5F provide optical microscope images of graphene aerogel before (FIGS. 5A, 5C, and 5E) and after (FIGS. 5B, 5D, and 5F) PCM impregnation, in accordance with an exemplary embodiment of the present invention.

FIG. 6 provides an example temperature versus time data of water and PCM samples cooled in a 0° C. ice water bath, in accordance with an exemplary embodiment of the present invention. The flattening of the PCM curve is due to the phase transition of the PCM from liquid to solid state.

FIG. 7 provides an example temperature versus time data of graphene aerogel/PCM and PCM samples cooled in a 0° C. ice water bath, in accordance with an exemplary embodiment of the present invention.

FIG. 8 provides an example temperature versus time data of graphene aerogel/PCM and PCM samples cooled in air in a freezer with an ambient temperature of −18° C., in accordance with an exemplary embodiment of the present invention.

FIG. 9 provides a photo of graphite powder/PCM showing settling of particulate after 1 cycle (left) and graphene aerogel/PCM after thermal cycling (right), in accordance with an exemplary embodiment of the present invention.

FIG. 10 is a flowchart illustrating an example method of forming a system comprising phase change material, in accordance with an embodiment of the present invention.

FIG. 11 is a flowchart illustrating an example method of forming a system comprising phase change material, in accordance with an embodiment of the present invention.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g. “about 90%” may refer to the range of values from 71% to 99%.

The large phase transition energies of this class of materials allow them to store and release significant amounts of energy through latent heat storage. This latent heat storage can be used in a number of ways. For example, solar energy can be stored in a PCM material during the day and then gradually released at night to heat a building. PCM materials can also be used as a heat sink for high power electronics to keep operating temperatures near a target temperature. Another use is in satellite systems, which can experience significant temperature fluctuations as they pass in and out of the Earth's shadow or due to the heat generated from onboard electronics during peak calculation periods. The PCM materials described herein can absorb excess heat generated by the onboard electronics or from the sunlight and then release it when the system is in the Earth's shadow and calculations are not ongoing, greatly reducing temperature fluctuations and the stress of thermal expansion and contraction.

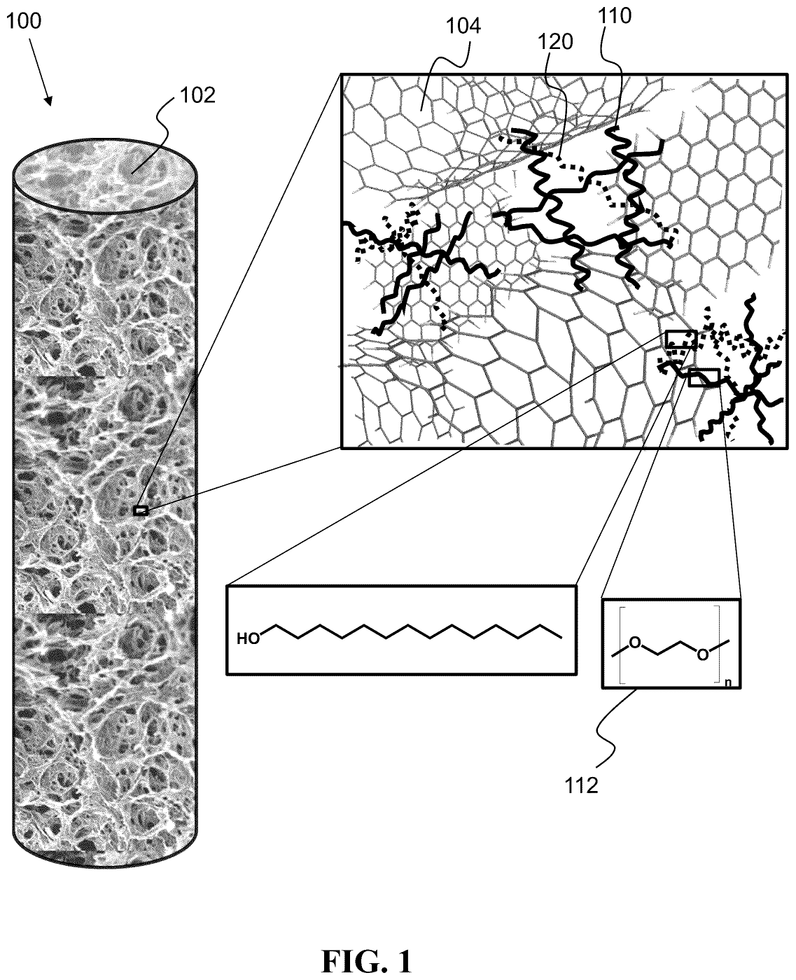

As shown in FIG. 1, an exemplary embodiment of the present invention provides a system 100 comprising an aerogel 102 and a first phase change material (PCM) 110 imbedded in the aerogel 102. System 100 can reversibly release and/or absorb sufficient energy at a phase transition to provide useful heating and/or cooling. In some embodiments, the phase transition can be between solid-liquid, solid-solid (e.g., a first crystalline conformation to a second crystalline conformation), solid-gas, liquid-gas, and combinations thereof. As a non-limiting example, when a phase change material 110 in a solid state is exposed to a high temperature, the phase change material 110 absorbs heat energy which melts or liquifies the material. Then, when the phase change material 110 in a liquid state is exposed to a low temperature, the phase change material 110 solidifies as heat energy is released back into the environment.

Aerogels are a class of synthetic porous ultralight material which the liquid component within a pore has been replaced with a gas. In general, aerogels can have open porosities as high as 99.9% (v/v). In some embodiments, aerogel 102 can function as a macroscopic support for first PCM 110. In some embodiments, aerogel 102 or macroscopic support can be made of carbon-based materials such as carbon nanotubes, carbon nanofibers, expanded graphite, graphene, graphene oxide, and the like. In some embodiments, the carbon-based material can be pure or doped with foreign elements such as metals (Au, Pd, Ru, Ni, Cu, etc.,), metal oxides (e.g., TiO₂, Al₂O₃, SiO₂, etc.,), organic components, and combinations thereof.

In some embodiments, the macroscopic support can also be made of silicon-based materials such as silicon carbide (α- or β-SiC or related SiC-based supports, either pure or doped with foreign elements such as TiO₂, Al₂O₃, SiO₂), silica, etc. It also can be made of aluminum-based materials such as alumina (α- or β-Al₂O₃ or related alumina-based supports, either pure or doped with foreign elements such as TiO₂, SiO₂, ZnO₂, Fe₂O₃, etc.,). The macroscopic material can also have a binary composition, such as SiC—Al₂O₃, SiC-silica, SiC-carbon, etc., and it can also be doped with different metal or metal-oxide dopants, such as TiO₂. Aerogel 102 can be made in any known form available in the art, for example grains, pellets, rings, foams, and the like.

Returning to FIG. 1, aerogel 102 comprises graphene 104. Graphene 104 can be densely packed in two-dimensional honeycomb lattices. Although not shown, graphene 104 can be, for example, wrapped into zero-dimensional fullerenes, rolled into one-dimensional nanotubes, stacked into three-dimensional graphite, reduced to graphene oxide, and combinations thereof. That is, graphene can be in a single layer of atomic carbon, but any number of layers (1, 2, 3, 4, 5, 6, 7, 8, 9, 10, or more, etc.) can be present in any portion of the macroscopic support. When in the form of graphene oxide, aerogel 102 comprises variable ratios of carbon and oxygen (“O/C ratio”) that can alter the electronics, thermal conductivity, and hydrophilicity of the material. For instance, aerogel 102 having a higher oxygen content generates a more hydrophilic phase change material 100.

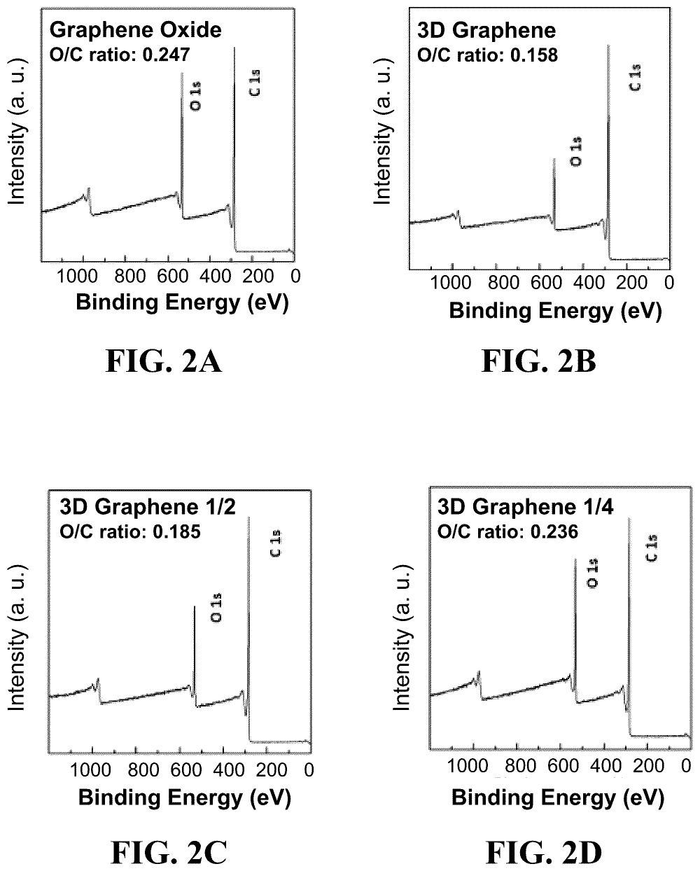

As shown in FIGS. 2A-2D, an O/C ratio equal to or greater than 0.20 may lead to higher hydrophilicity in the phase change material 100, while an O/C ratio equal to or less than 0.19 may generate of higher hydrophobic phase change material 100. Hydrophilicity properties of the phase change material 100 are beneficial for various applications of the material.

In some embodiments, aerogel 102 has an oxygen content that ranges between approximately 0.01 mol. % to 25 mol. %. When aerogel 102 has an oxygen content equal to or greater than 5.01 mol. %, the aerogel 102 is hydrophilic. An oxygen content between about 13 mol. % and 19 mol. % will result in a stably hydrophilic graphene. In some embodiments, an oxygen content greater than 20 mol. % may allow the graphene to completely disperse in water, which may be ideal in some applications of phase change materials. Alternatively, when aerogel 102 has an oxygen content equal to or less than 5 mol. %, the aerogel 102 is hydrophobic. In some embodiments, to make aerogel 102 more hydrophobic, additional conditioning is required to have such a low level of oxygen. For instance, aerogel 102 may undergo additional chemical treatment to reduce excess oxygen. In some embodiments, heat-treatment may be used to reduce oxygen content to below 5 mol. %. As would be understood by a person of skill in the relevant art, hydrophilicity is a spectrum such that the hydrophilicity of aerogel 102 may be adjusted by various techniques known in the field.

In some embodiments, the hydrophilicity of aerogel 102 is selected and altered based on the type of PCM 110 imbedded in system 100. For instance, when imbedding a PEG PCM, a hydrophilic aerogel 102 having an oxygen content equal to or greater than 6 mol. % is preferred.

In some embodiments, graphene 104 can be substantially planar in a single layer of graphene or can contain a related sp² graphite-like allotrope with multiple layers of graphene. In one embodiment, graphene 104 is sp in a hexagonal arrangement and has a thickness of one atom of a two-bonded carbon atom. In another embodiment, graphene 104 is a one-atom-thick planar sheet of sp²-bonded carbon atoms in a hexagonal arrangement in a honeycomb crystal lattice. In another embodiment, graphene 104 has a carbon-carbon bond with a length of about 0.142 nm.

In some embodiments, first PCM 110 is imbedded throughout the pores of aerogel 102. The first PCM 110 can undergo the phase transition within the porous structure of aerogel 102 that forms a shape-stabilizing composite. First PCM 110 is restricted in the pores of aerogel 102 owing to the weak interaction of capillary force or surface tension effect at the interfacial regions of graphene 104.

In certain embodiments, first PCM 110 comprises organic hydrocarbons or sugar alcohols that freeze without much supercooling and can melt congruently. Some example, first PCMs 100 can include, but are not limited to, eicosane, docosane, octadecanoic acid, tetradecanol, or combinations thereof. In some embodiments, first PCM 110 can be a polymer. In some embodiments, first PCM 110 as a polymer can be configured to reversibly crosslink with respective monomers 112 based on a transition temperature of first PCM 110. Polymers can include, without limitation, polyethylene glycol (PEG), polylactic acid (PLA), polyglycolide (PGA), polydioxanone (PDO), polylactide-co-glycolide (PLGA), polycaprolactone (PCL), polyethylenimine (PEI), hyaluronic acid, PEGylated hyaluronic acid, polyamino acid, perfluorocarbon (PFC), poloxamer (PPO), or combinations thereof.

In some embodiments, aerogel 102 may also include a second PCM 120 imbedded in the pores of aerogel 102. Second PCM 120 can be a different structure than first PCM 110. Second PCM 120 can react with first PCM 110. For instance, second PCM 120 may be any polymer identified above or may crosslink with another polymer and form co-polymers such as, for example, PEG-PCL, PEG-PEI, PEG-PLA, PEG-PLGA, PFC-PEG, PEG-PPO-PEG, stearyl methacrylate (SMA) and methyl methacrylate (MMA), and the like. As another example, second PCM 120 may be any polymer and first PCM 110 may be a sugar alcohol that fits within smaller pores of aerogel 102.

In some embodiments, first PCM 110 can comprise a polymer having a phase transition temperature suited for the application of the phase change material. The molecular weight of first PCM 110 and second PCM 120 can be increased or decreased to change the melting behaviors of the system 100. The molecular weight of first PCM 110 and/or second PCM 120 can range from between approximately 100 to approximately 40000. The transition temperature for example PCMs having a range in molecular weight are listed in Table 1 below.

TABLE 1
Example PCM transition temperature ranges.

| | Transition Temperature |
|---|---|
| Phase change material | and/or Range (° C.) |
| PEG100 | 39 |
| PEG1500 | 48.7 |
| PEG4000 | 61.3 |
| PEG6000 | 62.1 |
| PEG8000 | 55-60 |
| PEG20000 | 63-66 |
| PLA | 160-180 |
| PGA | 220-225 |
| PDO | 110 |
| PLGA | 240-280 |
| Eicosane | 35-37 |
| Docosane | 42-45 |
| Octadecanoic Acid | 65-69 |
| Tetradecanol | 35-37 |

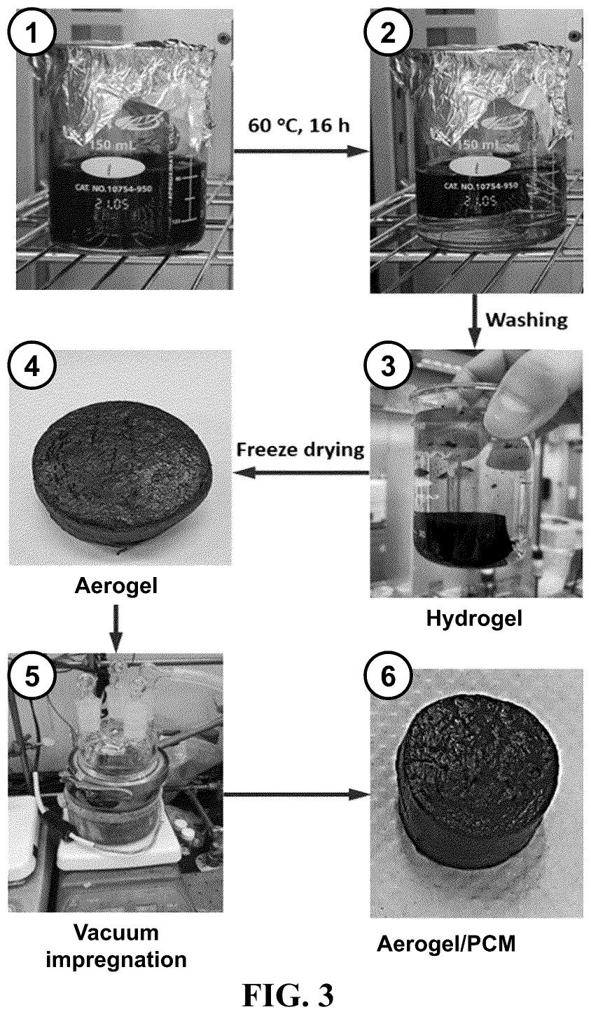

FIG. 3 provides step-by-step illustrations of an example system 100 preparation. In general, the aerogel precursors can be in a suspension at step 1. For carbon-based materials, a reducing agent such as L-ascorbic acid, cysteine hydrochloride, 2-mercaptoethanol, sodium sulfite, sodium thioglycolate, and the like, can be added to the carbon-based material in step 2. After washing, the carbon-based material can form a hydrogel in step 3. Formation of aerogel 102 can be conducted by any suitable method that removes moisture from a gel structure, such as lyophilization, freeze drying, supercritical drying, or combinations thereof. To form system 100, aerogel 102 is exposed to vacuum impregnation in the presence of melted and/or liquid first PCM 110 in step 5. The final product is the aerogel 102 comprising PCM 110 (“Aerogel/PCM”), as shown in step 6.

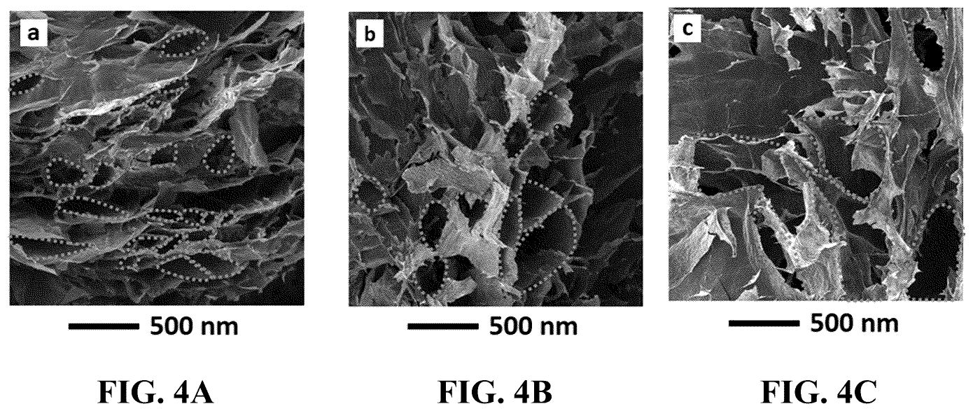

FIGS. 4A through 4C provide scanning electron microscope (SEM) images of graphene aerogels prepared at different ratios of reducing agent to graphene oxide (from steps 1 and 2 from FIG. 3). As shown, varying pore sizes are generated in aerogel 102 depending on ratio of reducing agent. FIG. 4A shows a ratio of reducing agent to graphene oxide of approximately 3:1. FIG. 4B was created with a ratio of reducing agent to graphene oxide of 3:2. FIG. 4C shows larger pores created with a ratio of reducing agent to graphene oxide of 3:4. Although not wishing to be bound by theory, in certain examples, smaller pore sizes result when lower amounts of reducing agent are mixed with graphene oxide; however, other variables will also change pore sizes such as, for example, concentration of reducing agent, time mixed, mixing temperature, humidity in the atmosphere, and the like.

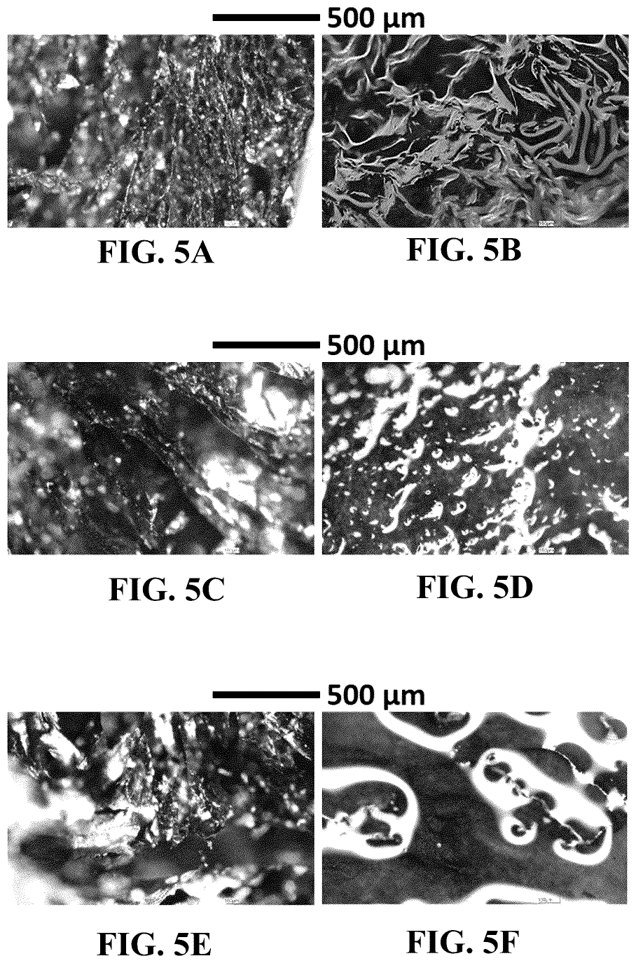

FIGS. 5A, 5C, and 5E show images of aerogel 102 before PCM impregnation. FIGS. 5D, and 5F provide images of aerogel 102 after impregnation of first PCM 110.

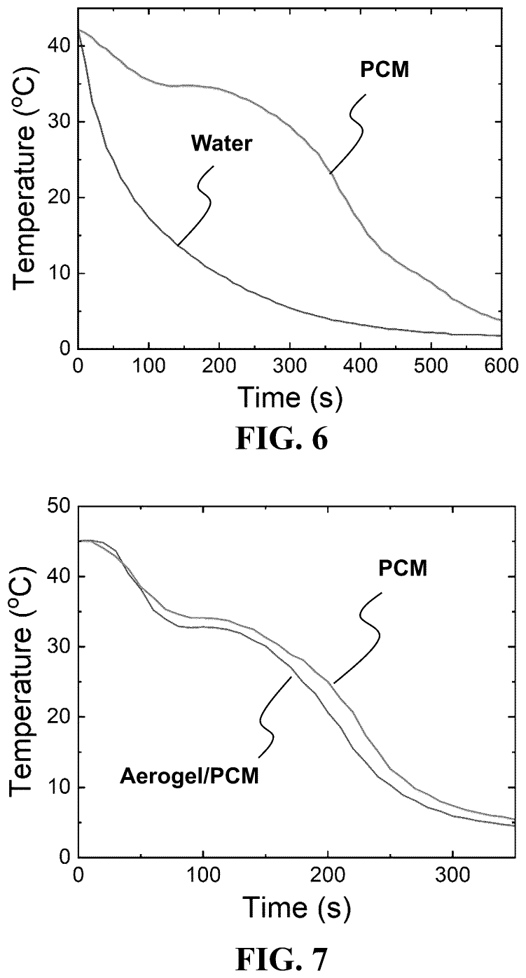

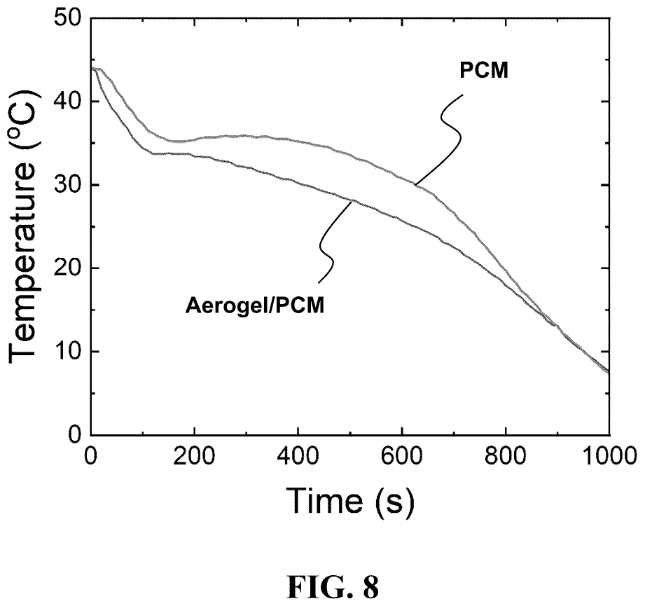

A T-history method allows for testing of the melting temperature, degree of supercooling, heat of fusion, specific heat, and thermal conductivity of several PCMs simultaneously. FIGS. 6-8 provide T-history of example PCMs compared to system 100 (aerogel/PCM). In certain examples, aerogel 102 having an effective average density of 13.7 mg/cm³ with graphene 104 making up approximately 1.3% of the total weight of system 100, a T-history test revealed a clear difference in the core temperature vs time for system 100 compared to the pure PCM samples during cooling. As shown in FIGS. 7 and 8, the core temperature of the aerogel/PCM samples dropped more rapidly upon being placed into the ice bath or freezer. In certain examples, a more rapid change in temperature is a clear indicator of an increased thermal conductivity.

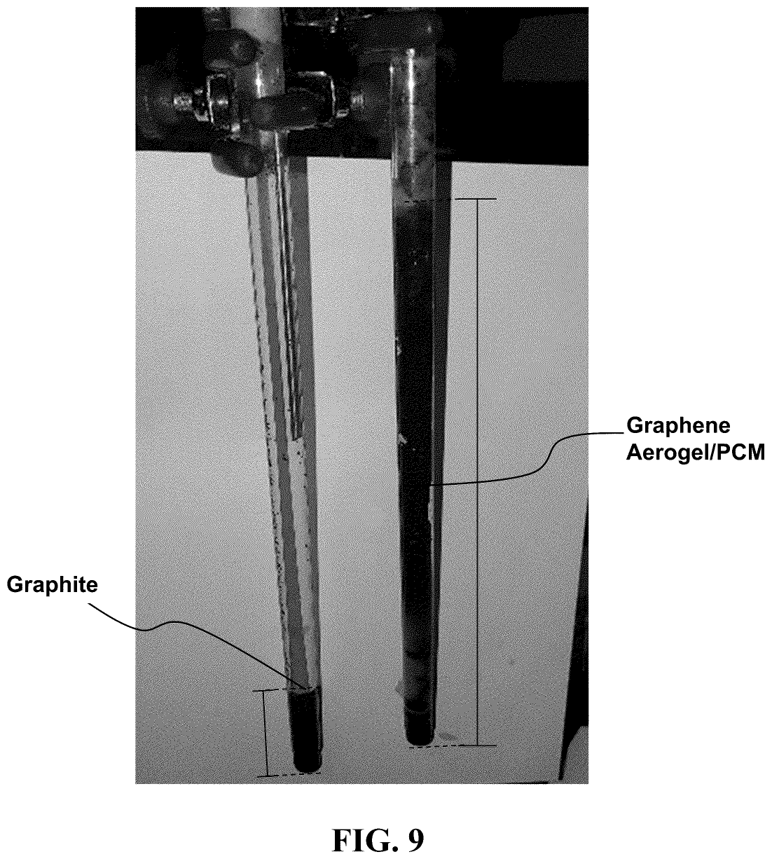

FIG. 9 provides a photo of side-by-side comparison of a non-aerogel material mixed with a PCM (left) and an example aerogel 102 with first PCM 110 (right). Notably, the non-aerogel support comprises carbon-based graphite powder. As shown, the graphite powder is settled at the bottom of the container after 1 round of thermal cycling. As used herein, thermal cycling is a repeated oscillation between temperatures. Energy flowing through several layers of tightly stacked materials causes devices to heat up, then rapidly cool down. In the non-aerogel system, the support material falls out of the stacking and fails to undergo multiple oscillations of thermal cycling. In comparison, graphene aerogel/PCM on the right maintains structure after thermal cycling.

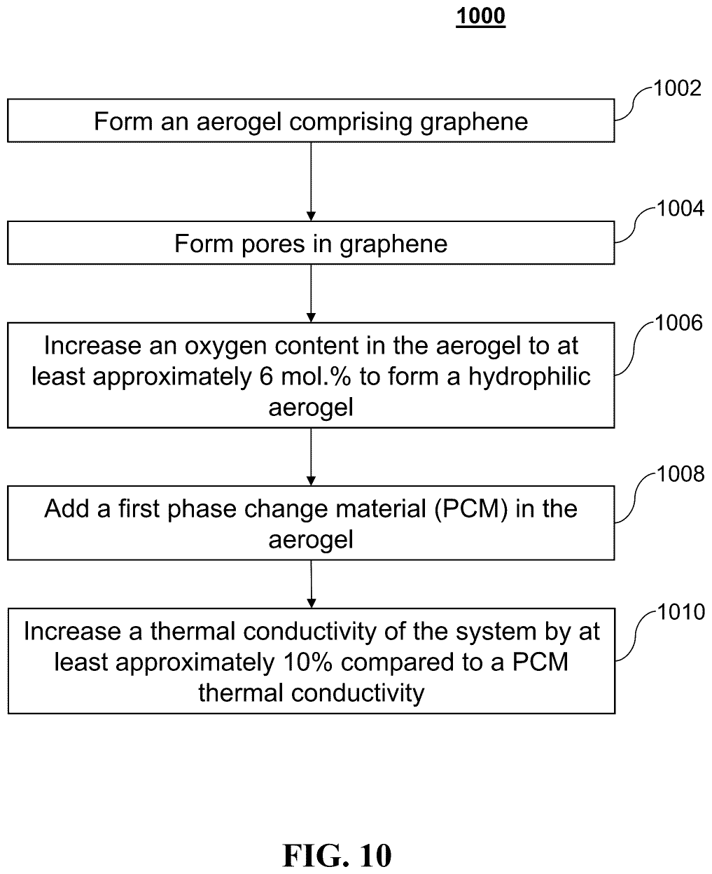

FIG. 10 is a flowchart of a method 1000 of forming a system 100 comprising phase change material. Method 1000 can include forming an aerogel 102 comprising graphene 104 at step 1002. Method 1000 further includes forming pores in graphene 104 using a suitable technique to remove moisture from the gel material, such as lyophilization, freeze drying, supercritical drying, or combinations thereof in step 1004. The method 1000 can include increasing an oxygen content in the aerogel 102 to at least approximately 6 mol. % to form a hydrophilic aerogel at step 1006. The method 1000 can further include adding a first phase change material (PCM) 110 in aerogel 102 in step 1008. As described herein, the first PCM 110 can be selected based on they hydrophilicity of aerogel 102. Finally, method 1000 can include step 1010 of increasing a k-value, or thermal conductivity of system 100 by at least approximately 10% compared to a PCM thermal conductivity. As will be appreciated, the method 1000 can include any of the previous examples described herein.

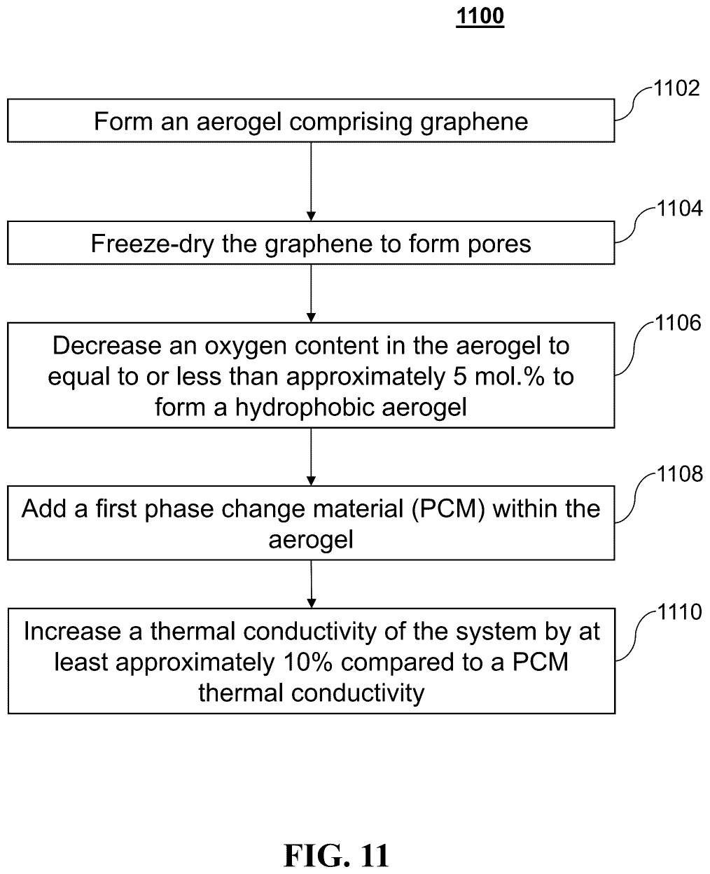

FIG. 11 is a flowchart of a method 1100 of forming a system 100 comprising phase change material. Method 1100 can include forming an aerogel 102 comprising graphene 104 at step 1102. Method 1100 further includes freeze drying the graphene 104 to form pores in aerogel 102 in step 1104. The method 1100 can include decreasing an oxygen content in the aerogel 102 to equal to or less than 5 mol. % to form a hydrophobic aerogel at step 1106. The method 1100 can further include adding a first phase change material (PCM) 110 in aerogel 102 in step 1108. Finally, method 1100 can include step 1110 of increasing a k-value or thermal conductivity of system 100 by at least approximately 10% compared to a PCM thermal conductivity. As will be appreciated, the method 1100 can include any of the previous examples described herein.

As used herein, the “k-value” means the comparison of thermal conductivity of a material and specifies the rate of heat transfer. As a non-limiting example, a 1 m³ cube of material with a k-value of 1 will transfer heat at a rate of 1 watt for every degree of temperature difference between opposite faces. The k-value is expressed as 1 W/mK. In some embodiments, the lower the k-value, the less heat the material will transfer. In some embodiments, system 100 can have a k-value that is at least approximately 10% greater compared to a k-value of pure PCM. For instance, an example system described herein has a thermal conductivity equal to about 0.482 Watts per meter-Kelvin (W/mK), while pure PCM has a thermal conductivity of approximately 0.369 W/mK, an increase by approximately 24%. When first PCM 110 is embedded in aerogel 102, the thermal conductivity of system 100 increases by at least about 10%. In some embodiments, the thermal conductivity of phase change material 100 increases by up to 50% compared to the thermal conductivity of pure PCM.

Modified transient plane source (MTPS) sensor is a method that employs a single-sided sensor to directly measure thermal conductivity, effusivity, and other thermophysical properties of materials such as those described herein. The single-sided sensor comprises a guard ring that can accommodate solids, liquids, powders, and pastes. The MTPS sensor has a wide measurement range of 0-500 W/mK, and a temperature range of about −50 to about 500° C.

TABLE 2
Thermal conductivity of Aerogel/PCM
samples measured by the MTPS method.

| | Avg. kₛ | Standard | |
|---|---|---|---|
| Sample Batch | (W/m · K) | deviation, σ | % Increase |
| PCM | 0.356 | 0.002 | — |
| Aerogel/PCM-1 | 0.380 | 0.003 | 7.80% |
| Aerogel/PCM-2 | 0.416 | 0.002 | 17.96% |
| Aerogel/PCM-3 | 0.403 | 0.003 | 14.11% |

In some embodiments, graphene 104 is formed into porous aerogel 104 such that the density of the system 100 before PCM impregnation ranges between about 0.001 g/cm³ to about 0.05 g/cm³. After impregnation of first PCM 110, the density of the system 100 increases significantly, as shown in Table 3 below.

TABLE 3
Thermal conductivity of Aerogel/PCM
samples measured by the MTPS method.

| | Mass (g) | Mass (g) | Density | Density | |
|---|---|---|---|---|---|
| | before | after | before | after | Wt. % |
| Sample | impreg- | impreg- | impregnation | impregnation | of |
| Batch | nation | nation | (g/cm³) | (g/cm³) | Aerogel |
| Sample 1 | 0.188 | 13.0 | 0.0042 | 0.288 | 1.45% |
| Sample 2 | 0.192 | 14.4 | 0.0025 | 0.189 | 1.33% |
| Sample 3 | 0.160 | 14.5 | 0.0017 | 0.153 | 1.10% |

In some embodiments, the ratio of first PCM 110 to graphene 104 comprises from approximately 0.01 wt. % to approximately 3 wt. % of graphene, based on a total weight of the system 100. The system 100 can have a ratio of graphene 104 to first PCM 110 of between approximately 1:1000 to approximately 1:33.

As would be appreciated by one of skill in the art, the type of PCM and density of PCM impregnated in aerogel 102 can be adjusted based on the application of system 100. Some nonlimiting example applications can include thermal energy storage, such as the FlexTherm Eco by Flamco; solar cooking; cold energy battery; conditioning of buildings, such as ‘ice-storage’; cooling of heat and electrical engines; cooling of foods, beverages, coffee, wine, milk products, green houses; delaying ice and frost formation on surfaces; medical applications: transportation of blood, operating tables, hot-cold therapies; human body cooling under bulky clothing or costumes; waste heat recovery; off-peak power utilization such as heating hot water; heat pump systems; passive storage in bioclimatic building/architecture (high-density polyethylene, paraffin); smoothing exothermic temperature peaks in chemical reactions; solar power plants; spacecraft thermal systems; thermal comfort in vehicles; thermal protection of electronic devices; thermal protection of food; textiles used in clothing; computer cooling; turbine inlet chilling with thermal energy storage; telecom shelters in tropical regions; and the like.

The following examples further illustrate aspects of the present disclosure. However, they are in no way a limitation of the teachings or disclosure of the present disclosure as set forth herein.

### EXAMPLES

### Example 1—Sample Preparation and Characterization

Three-dimensional (3D) graphene hydrogel was first synthesized from a commercial graphene oxide (GO) water suspension (MSE Supplies). L-ascorbic acid (L-AA, 99%, Sigma-Aldrich) was added to a GO suspension (4 mg/mL) as a reducing agent for cross-linking the GO sheets. After dissolution of the L-AA, the reaction solution was placed in an oven at 60° C. for 16 hours to obtain a graphene hydrogel. Freeze-drying was performed to obtain 3D graphene aerogels by removing water from the 3D graphene hydrogel samples, maintaining their original porous structures. A vacuum-impregnation process was then employed to prepare 3D graphene aerogel/PEG composite samples (Gr/PEG). The solid-phase polyethylene glycol (PEG, MW1000, Sigma-Aldrich) was transferred into a reactor and heated at 70° C. for conversion to a liquid phase. The 3D graphene aerogel was then added into the reactor followed by evacuation for effectively impregnating the PEG into the pores of 3D graphene. The Gr/PEG samples were dried in air at room temperature and cut into a specific dimension for follow-on characterization. The initial preparation used for the T-history test samples comprised a 3:1 ratio of L-ascorbic acid to graphene by weight. In some examples, the ratio was varied in order to control the porosity and density of the graphene aerogels. For the modified transient plane source (MTPS) testing, three example batches were prepared: Gr/PEG-1, Gr/PEG-2, and Gr/PEG-3, which had ratios of 3:1, 3:2, and 3:4 L-AA to GO powder by weight, respectively.

Morphologies of the 3D graphene aerogels and their pore structure were observed by a scanning electron microscope (SEM, SU8230, Hitachi). Optical microscopy (VHX-7000, Keyence) was carried out for observing sections of both graphene aerogels (Gr) and Gr/PEG samples. Thermophysical property measurement approaches were used as next described.

### Example 2—T-History Testing

The T-history method is a technique that can be used for the determination of multiple thermophysical properties of various phase change materials. The T-history technique is known to be suitable for extracting critical PCM properties including thermal conductivity, enthalpy of fusion, and specific heat. The experimental setup includes logging temperature as a PCM sample is cooled through its transition temperature. A cylindrical sample having a length to diameter ratio of over 15 was used such that the heat transfer was measured as one-dimensional in the radial direction. The temperature vs time curve of the PCM as it is heated or cooled is compared to that of a reference sample (typically water) and the critical parameters are extracted from a set of equations described herein.

In one example, borosilicate glass tubes with an ID of 0.38″ and OD of 0.5″ were used to contain the PCM materials. The samples prepared were 10″ long to attain the necessary aspect ratio for the T-history technique. A 6″ type-K thermocouple probe was inserted into the center of the cylindrical sample to measure the core temperature as it was heated and cooled between 0° C. and 50° C. The thermal conductivity, kₛ, of the PCM in the solid state can then be calculated from equation (1):

$${k}_{s} = \frac{1 + \frac{{c}_{p} ( {T}_{m} - {T}_{∞ , w} )}{{H}_{m}}}{4 ( \frac{{t}_{f} ( {T}_{m} - {T}_{∞ , w} )}{{ρ}_{p} {R}^{2} {H}_{m}} - \frac{1}{{h}_{w} R} )} \qquad Eq . ( 1 )$$

Where cₚ is the specific heat of the material of the tube, Tₘ is the melting temperature of the PCM, T_{∞} is the temperature of the atmosphere (which can be time dependent), R is the radius of the tube, t_{f} is the time of full solidification of the molten PCM, ρₚ is the density of the PCM, h_{w} is the coefficient for convective heat transfer from the tube to the stirred cool water, and Hₘ is the heat of fusion of the PCM and is defined by equation (2) below:

$${H}_{m} = \frac{{m}_{w} {c}_{p , w} + {m}_{t} {c}_{p , t}}{{m}_{p}} \frac{{A}_{2}}{{A}_{1}^{′}} ( {T}_{0} - {T}_{m , 1} ) - \frac{{m}_{t} {c}_{p , t} ( {T}_{m , 1} - {T}_{m , 2} )}{{m}_{p}} \qquad Eq . ( 2 )$$

Where m_{w} is the mass of the atmosphere, c_{p,w} is the mean specific heat of the atmosphere, mₜ is the mass of the tube, c_{p,t} is the mean specific heat of the material of the tube, mₚ is the mass of the PCM, A₂ is ∫ₜ_{₁}^{t}^{₂}(T−T_{∞a})dt (t₁→t₂ is the time during which a phase-change process occurs), A′₁ is ∫₀^{t′}^{₁}(T−T_{∞a})dt, T₀ is the initial temperature of the PCM, and T_{m,1} and T_{m,2} are the temperature range of the phase-change process for the PCM. In the present example, the atmosphere is water.

### Example 3—MTPS Testing

The modified transient plane source (MTPS) method directly measures thermal conductivity and effusivity of materials using a one-sided heat reflectance sensor. The device applies small momentary heat pulses to the sample while monitoring the change in interface temperature via a small voltage sensor. The thermal conductivity is inversely proportional to the rate of temperature increase and thus by monitoring the change in interface temperature versus time the thermal conductivity can be determined. For this work a C-Therm TCi thermal conductivity analyzer with MTPS sensor was used.

### Example 4—Results and Discussion

Preparation of Gr/PEG samples was done in a method like that of FIG. 3. After the chemical reduction of GO suspension with L-AA in steps 1 and 2, graphene sheets were converted into a hockey puck-shape graphene hydrogel. As oxygen functional groups on the surface of GO sheets were partially removed by the chemical reduction, π-π interactions in between reduced GO sheets could cause their gelation, resulting in formation of the graphene hydrogel in step 3.

The freeze drying effectively removes water and other hydrates from the pores of the hydrogel, generating the graphene aerogel in step 4, without any changes in overall morphology as well as volume, which indicates the porous structure of the graphene hydrogel were well maintained during the freeze-drying process. The pore volumes of the graphene aerogels were controlled by varying the weight ratio of L-AA to GO for Gr-1, Gr-2, and Gr-3 at 3:1, 3:2, and 3:4, respectively. The volumetric densities of Gr-1, Gr-2, and Gr-3 were 0.0025, and 0.0017 g/cm³, respectively. These results indicate the more L-AA added into the reaction solution could lead to more reduction of GO due to higher reducing power, resulting in more π-π stacking of the sheets and thus reducing the pore size and volumes.

SEM analysis confirmed that the pore size increased while the wt. ratio of L-AA to GO decreased from 3:1 (Gr-1) to 3:2 (Gr-2) and 3:4 (Gr-3). For all three graphene aerogel samples, well-defined porous structures were observed. The graphene aerogel prepared at lower L-AA to GO ratio were composed of larger-sized pores. Optical microscope images in FIGS. 4A through 4C, show that the pores of all graphene aerogels (Gr-1, Gr-2, and Gr-3) were filled with the PEG1000 through the vacuum impregnation process in step 5 of FIG. 3.

The aerogels prepared for the T-history were found to have an effective average density of 13.7 mg/cm³ and accounted for 1.3% of the total weight of the final Gr/PEG composites as shown in FIGS. 6-8. The T-history test revealed a clear difference in the core temperature vs time for the graphene infused samples compared to the pure PEG samples during cooling. The core temperature of the Gr/PEG samples dropped more rapidly upon being placed into the ice bath or freezer, a clear indicator of the increased thermal conductivity imparted by the graphene aerogel. Using Eq. (1) and assuming

$$\frac{{t}_{f} ( {T}_{m} - {T}_{∞ , w} )}{{ρ}_{p} {R}^{2} {H}_{m}} >> \frac{1}{{h}_{w} R}$$

with Tₘ=37° C. and Tₛ=30° C. the thermal conductivity of the PEG and Gr/PEG is determined from the cooldown runs. Based on a total of four measurements, two using an ice bath and two using room temperature water bath, an average thermal conductivity of 0.42 W/m·K for the Gr/PEG vs 0.37 W/m·K for the pure PEG was calculated, which is approximately 13% increase. It is important to note that the values for thermal conductivity were quite sensitive to the selection of Tₛ and Tₘ, which is why confirmation of the thermal conductivity via the MTPS method was critical. However, the effect of the thermal conductivity increase was clear and repeatable in the T-History data throughout repeated thermal cycling.

As shown in FIG. 9, the 3D graphene aerogel is the ability to maintain its structure and uniformity during thermal cycling. To demonstrate the importance of this property, a thermal cycle test was done using PEG infused with graphite nanoparticles to compare to the Gr/PEG system. Although a relatively uniform dispersion was obtained initially, the graphite particles almost completely settled after only one thermal cycle. The structural resiliency of the graphene aerogel compared to particulate additives is a major improvement that is critical for long term system performance.

For the MTPS testing, four samples were fabricated using each of the three different graphene aerogel preparations and infused with PEG. As discussed previously, the ratio of L-AA reducing agent to graphene oxide was varied in order to change the graphene aerogel densities. Reducing the amount of L-AA resulted in lowering volumetric density of the graphene aerogels due to differences in remaining oxygen functional groups, which decrease interlayer attraction and stacking. To quantify the ratio of oxygen to carbon for each aerogel preparation, X-ray photoelectron spectroscopy (XPS) can be used. Increasing oxygen functional groups during a secondary thermal reduction of the aerogel could improve performance of the system because oxygen functionalization is known to reduce the thermal conductivity of graphene. The graphene aerogel density was lower for all 3 of the preparations used in MTPS testing than for the previous T-history samples due to the container shape. The increased compaction during sample drying may be due to T-history test samples formed within long vertical tubes.

Table 4. Volumetric density of graphene aerogels and Gr/PEG samples
prepared at different L-AA to GO ratio for the MTPS testing.

| | Gr Aerogel Density | Gr Weight Percent in |
|---|---|---|
| Sample Batch | (mg/cm³) | Gr/PEG composite |
| Gr/PEG-1 | 4.2 | 1.45% |
| Gr/PEG-2 | 2.5 | 1.33% |
| Gr/PEG-3 | 1.7 | 1.10% |

All three batches showed an increase in average thermal conductivity relative to the pure PEG control samples, although there was perceptible variation within each batch. Gr/PEG-2 showed the greatest increase in thermal conductivity, with a roughly 30% increase relative to the PEG control sample. The expectation was that the highest density graphene samples, Gr/PEG-1, would show the greatest increase in thermal conductivity so it was surprising to find that Gr/PEG-2 resulted in the largest thermal conductivity increase.

TABLE 5
Thermal conductivity of Gr/PEG samples
measured by the MTPS method.

| | Avg. kₛ | Standard | |
|---|---|---|---|
| Sample Batch | (W/m · K) | deviation, σ | % increase |
| PEG | 0.369 | 0.055 | — |
| Gr/PEG-1 | 0.416 | 0.064 | 13% |
| Gr/PEG-2 | 0.482 | 0.065 | 30% |
| Gr/PEG-3 | 0.420 | 0.038 | 14% |

An aerogel presenting less stacking and clumping due to the additional oxygen functional groups may lead to a more uniform graphene distribution, as is shown in sample Gr/PEG-2. Additional oxygen functional groups may have also made for a better interface with the hydrophilic PEG.

The results of the disclosed invention demonstrated the potential for significant and stable PCM thermal conductivity enhancement through the addition of a small amount of graphene aerogel. Furthermore, the graphene aerogel's ability to maintain its structure and bulk thermal conductivity enhancement during thermal cycling was also confirmed. This promising hybrid system warrants further research as more precise control of the graphene aerogel properties and uniformity could lead to a robust graphene/PCM hybrid well-suited to meet the energy storage and thermal management needs of the future.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A system comprising:
an aerogel comprising graphene; and
a first phase change material (“PCM”) imbedded in the aerogel.

2. The system of claim 1, wherein a thermal conductivity of the system increases by at least approximately 10 percent compared to a PCM thermal conductivity.

3. The system of claim 1, wherein the first PCM comprises eicosane, docosane, octadecanoic acid, tetradecanol, a polymer, or combinations thereof.

4. The system of claim 1, wherein the first PCM comprises a polymer configured to reversibly crosslink with respective monomers of the polymer based on a phase transition temperature.

5. The system of claim 4, wherein the polymer comprises polyethylene glycol (PEG), polylactide (PLA), polyglycolide (PGA), polydioxanone (PDO), polylactide-co-glycolide (PLGA), or combinations thereof.

6. The system of claim 1, wherein the system comprises from approximately 0.01 wt. % to approximately 3 wt. % of graphene, based on a total weight of the system.

7. The system of claim 6, wherein the system comprises a ratio of graphene to first PCM of between approximately 1:1000 to approximately 1:33.

8. The system of claim 1, further comprising a second PCM imbedded in the aerogel, the second PCM different than the first PCM.

9. The system of claim 1, wherein the aerogel comprises an oxygen content between approximately 0.01 mol. % and 25 mol. %.

10. The system of claim 1, wherein the aerogel comprises an oxygen content of at least approximately 6 mol. %, and wherein the aerogel is hydrophilic.

11. The system of claim 1, wherein the aerogel comprises an oxygen content equal to or less than approximately 5 mol. %, and wherein the aerogel is hydrophobic.

12. A method of forming a system comprising phase change material (“PCM”), the method comprising:
forming an aerogel comprising graphene,
wherein the aerogel comprises an oxygen content ranging from between approximately 0.1 mol. % to approximately 25 mol. %; and
adding a first PCM within the aerogel.

13. The method of claim 12, further comprising increasing a thermal conductivity of the system by at least approximately 10 percent compared to a PCM thermal conductivity.

14. The method of claim 12, wherein forming an aerogel comprises reducing graphene oxide to form graphene.

15. The method of claim 14, forming an aerogel further comprises freeze-drying the graphene to form pores.

16. The method of claim 15, wherein adding the first PCM in the aerogel further comprises exposing the aerogel and the first PCM to a vacuum.

17. The method of claim 12, wherein the system comprises from approximately 0.01 wt. % to approximately 3 wt. % of graphene, based on a total weight of the system.

18. The method of claim 11, wherein the first PCM comprises eicosane, docosane, octadecanoic acid, tetradecanol, polyethylene glycol (PEG), polylactide (PLA), polyglycolide (PGA), polydioxanone (PDO), polylactide-co-glycolide (PLGA), or combinations thereof.

19. The method of claim 12, further comprising increasing an oxygen content in the aerogel to at least approximately 6 mol. % to form a hydrophilic aerogel.

20. The method of claim 11, further comprising decreasing an oxygen content in the aerogel equal to or less than approximately 5 mol. % to form a hydrophobic aerogel.
